(19) United States
(12) Patent Application Publication
(10) Pub. No.: US 2006/0085265 A1
(43) Pub. Date: Apr. 20, 2006

(54) System and method for restaurant electronic menu

(75) Inventors: Timothy Alan Dietz, Austin, TX (US); Lane Thomas Holloway, Pflugerville, TX (US); Marques Benjamin Quiller, Pflugerville, TX (US)

Correspondence Address: IBM CORPORATION- AUSTIN (JVL);C/O VAN LEEUWEN & VAN LEEUWEN, PO BOX 90609, AUSTIN, TX, 78709-0609, US

(73) Assignee: International Business Machines Corporation, Armonk, NY (US)

(21) Appl. No.: 10/932,755

(22) Filed: Sep. 2, 2004

(51) Int. Cl. G06Q 30/00

(52) U.S. Cl. 705/15

(57) ABSTRACT

A system and method that provides an electronic menu wirelessly interconnected with a restaurant's server is provided. The restaurant server provides the electronic menu device with the menu items and menu software used to navigate through the menu items and options. The electronic menu provides the patron with details regarding menu items including detailed descriptions, photographs and videos, and nutritional information. The patron's order is wirelessly transmitted to the restaurant server and communicated to the restaurant kitchen staff. The electronic menu device is also used to request assistance and request the status of an order that has been placed. The patron can pay using the electronic menu device by providing credit card information or the patron can request assistance and provide payment, such as cash, to the restaurant's wait staff.

### BACKGROUND OF THE INVENTION

1. Technical Field

The present invention relates in general to a system and method for providing electronic restaurant menus. In particular, the present invention relates to a system and method for providing a wireless electronic menu that interacts with a restaurant server.

2. Description of the Related Art

Traditional restaurant menus often lack information that consumers would like to have before making their order. Pictures, in-depth description, and nutritional information is often lacking. In addition, changes to the menu or “daily specials” are often poorly communicated to customers. Daily specials are often hand-written on a chalk board or white board near the front of the restaurant or printed on loose pieces of paper that are slipped into the menu. The problem with these approaches is that the patron often forgets the daily special by the time he or she is seated and loose pieces of paper often fall out of the menu. The problem with in-depth information, including pictures, in-depth descriptions, and nutritional information, is that providing this information in a traditional menu takes additional space, making the menu overly large and cumbersome to handle. In addition, when something changes, it is difficult to change the traditional menu. Often changes, such as price increases, are taped or written over the original price making the menu look less professional. However, printing new menus every time something changes is exceedingly expensive for most restaurants.

The above described challenges with traditional restaurant menus are further exacerbated when dealing with a person with particular dietary needs. For example, someone with a food allergy needs to know whether the food they are ordering contains any traces of the food that causes the allergic reaction. Wait staff that assists customers often has a high degree of turnover and, therefore, does not always know specific details regarding items that appear on the menu.

What is needed, therefore, is a system and method that provides an up-to-date electronic restaurant menu with detailed information regarding menu items. Further, what is needed is an electronic menu that provides a patron with the status, such as the amount of time to completion, for their order. Finally, what is needed is an electronic menu that allows the patron to order directly from the menu without having to wait for wait staff and that also allows the patron to pay using the electronic menu rather than entrusting the patron's credit card to an unknown wait staff person.

### SUMMARY

It has been discovered that the aforementioned challenges are resolved using a system and method that provides an electronic menu that is wirelessly interconnected with a restaurant's server. The electronic menu runs on a portable computing device (the electronic menu device), such as a tablet PC. The restaurant server provides the electronic menu device with the menu items as well as menu updates, such as daily specials, and menu software used to navigate through the menu items and options.

When requested by the patron, the electronic menu provides the patron with details regarding menu items including detailed descriptions, photographs and videos, and nutritional information. Frequently requested information can be stored on the electronic menu device for faster retrieval, while less frequently requested information can be stored on the restaurant server and transmitted to the electronic menu device upon request in order to conserve storage space on the electronic menu device.

The patron navigates through the electronic menu using a touch screen or other input mechanism. The patron places his or her order which is wirelessly transmitted to the restaurant server and communicated to the restaurant kitchen staff. The patron can also use the electronic menu device to request assistance and request the status of an order that has been placed. The patron can pay using the electronic menu device by providing credit card information or the patron can request assistance and provide payment, such as cash, to the restaurant's wait staff.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a screen depiction of an electronic menu;

FIG. 2 is a screen depiction of nutritional information being provided using the electronic menu;

FIG. 3 is a screen depiction of an item's detailed description being provided using the electronic menu;

FIG. 4 is a screen depiction of photographic and video information being provided for a menu item using the electronic menu;

FIG. 5 is a screen depiction of an order detail being provided for a menu item using the electronic menu;

FIG. 6 is a screen depiction of order progress information being provided using the electronic menu;

FIG. 7 is a screen depiction of a payment screen being provided using the electronic menu;

FIG. 8 is a data flow diagram showing data flowing between the electronic menu device and the restaurant server;

FIG. 9 is a high level flowchart showing functions performed by the electronic menu device;

FIG. 10 is a flowchart showing the steps taken in initializing an electronic menu device from the restaurant server;

FIG. 11 is a flowchart showing the steps taken to handle an information request received from a patron of the electronic menu device;

FIG. 12 is a flowchart showing the steps taken to process a patron's selection from the electronic menu;

FIG. 13 is a flowchart showing the steps taken by the electronic menu device and the restaurant server to place an order;

FIG. 14 is a flowchart showing the steps taken to respond to an assistance request received from a patron that is using an electronic menu device;

FIG. 15 is a flowchart showing the steps taken to respond to a status inquiry request received from a patron that is using an electronic menu device;

FIG. 16 is a flowchart showing the steps taken to handle payment and checkout by the patron using the electronic menu device; and

FIG. 17 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

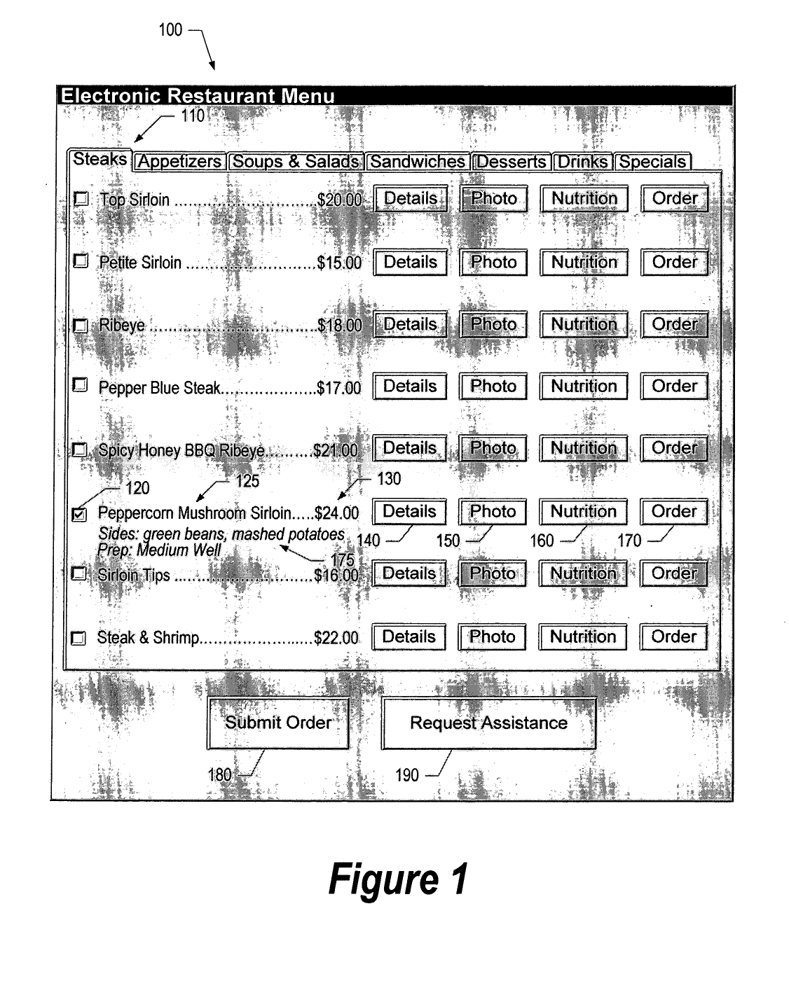

FIG. 1 is a screen depiction of an electronic menu being displayed on an electronic menu device. Electronic menu 100 includes a number of tab controls 110 that are selected by the patron in order to switch views between the various categories of food offered by the restaurant. As used herein, a “patron” is a user of the electronic menu device and is a patron of the restaurant in which the electronic menu device and restaurant server are used. In the example shown in FIG. 1, the “Steaks” category is being displayed. The title of each offering is provided along with the price. In addition, to the left of each title is an option box showing whether the particular item has been ordered. In an alternate embodiment, a numerical textbox can be provided showing the patron the number, or quantity, of each item that has been selected. This alternate embodiment might work better where electronic menu devices are limited to one per table with each person at the table ordering from the same electronic menu device.

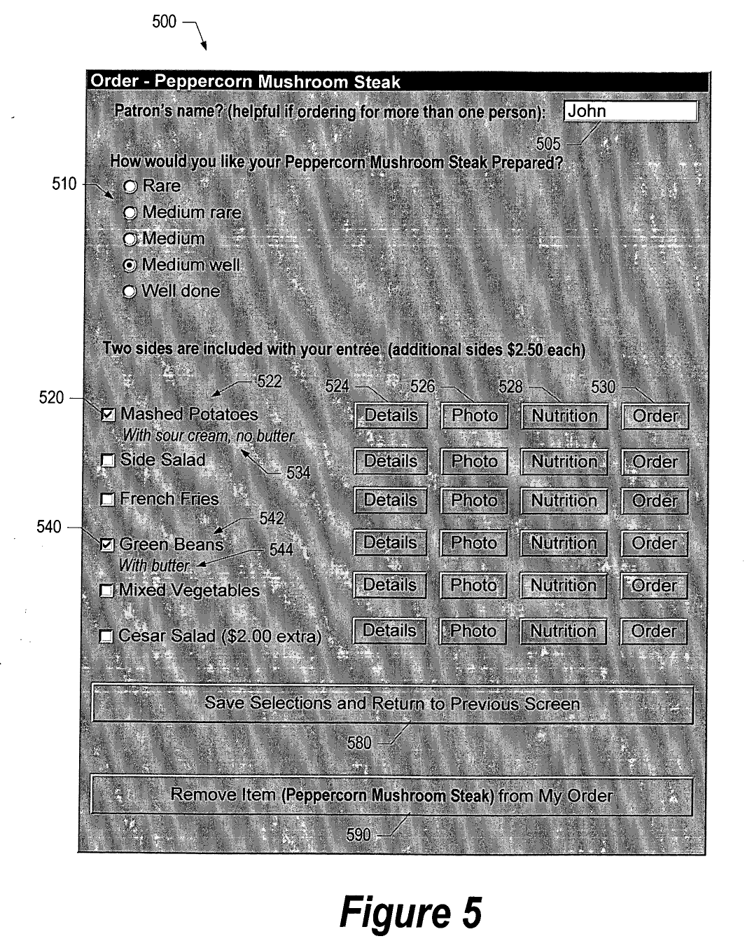

In the example shown in FIG. 1, the patron has ordered the “Peppercorn Mushroom Sirloin” steak (title 125), as indicated by checked option box 120. Along with each title featured on the menu are a number of command buttons used to view various information concerning a particular item. These command buttons include a button to view details about an item, a photo (or video) of the item, nutrition information concerning the item, and a button to order the item. In the example shown, the Peppercorn Mushroom Sirloin steak item 125 is associated with details command button 140, photo command button 150, nutrition command button 160, and order command button 170. In the example shown, the patron has ordered the steak cooked “medium well” and has ordered two side dishes to go with the steak, as seen in order summary 175. For the Order screen used to indicate order selections and preferences, see FIG. 5 and its corresponding detailed description.

Returning to FIG. 1, when the patron is satisfied with his selections, he selects submit order command button 180 to send his order to the restaurant server for processing and preparation. If the patron has any questions not answered by the electronic menu, he can select command button 190 to request assistance. If assistance is requested, a wireless message is sent from the electronic menu device to the restaurant server and relayed to a wait staff member, informing the member that the patron needs assistance along with providing location information (table number, etc.) corresponding to the patron.

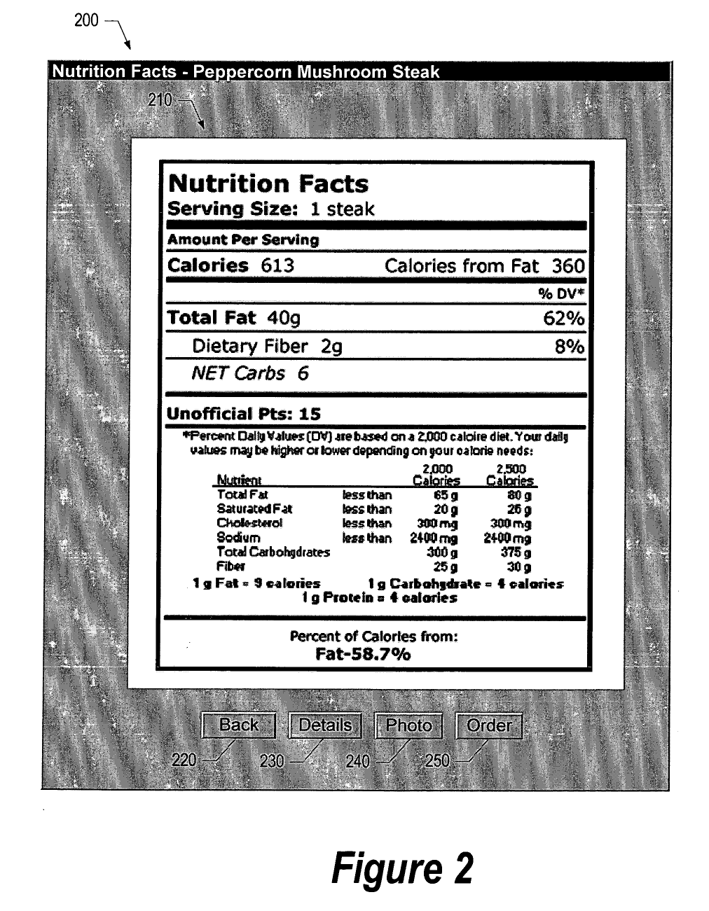

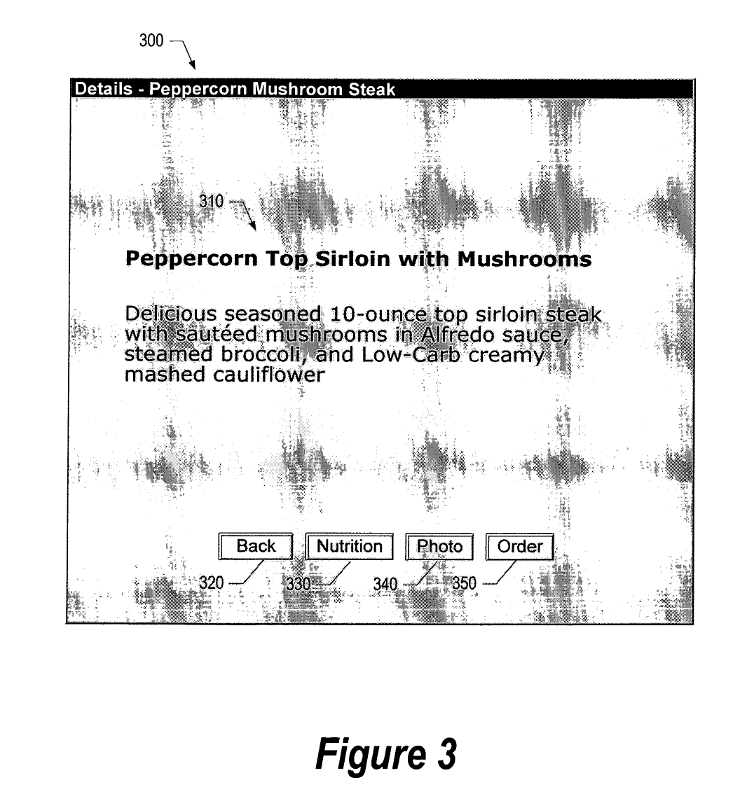

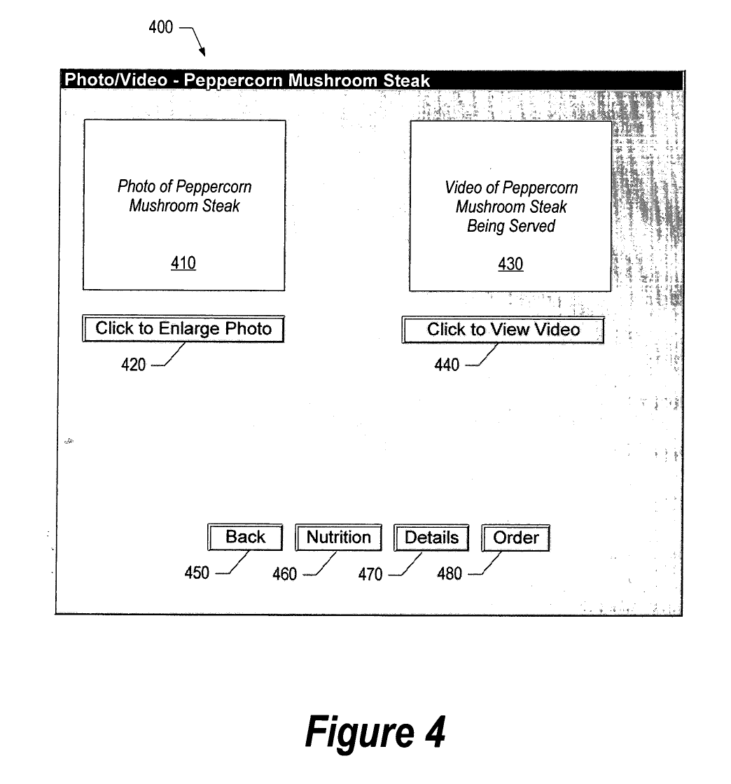

FIG. 2 is a screen depiction of nutritional information being provided using the electronic menu. When the patron requests nutritional information (such as by selecting nutrition command button 160 shown in FIG. 1), nutrition window 200 is displayed. Nutrition window 200 includes nutrition facts 210 that includes various nutrition data regarding a particular item. In the example shown in FIG. 2, the nutrition data corresponds to the “Peppercorn Mushroom Sirloin,” steak as indicated by the title bar of window 200. From window 200, the patron can navigate to other windows. Back command button 220 takes the patron back to the window from which the patron came, similar to a back command button in an Internet browser application. Details command button 230 is used to display a window with a detailed description of the item, in this case the “Peppercorn Mushroom Sirloin” steak (see FIG. 3 for an example of a detailed description window). Likewise, photo command button 240 is used to display a photograph and/or video of the “Peppercorn Mushroom Sirloin” steak (see FIG. 4 for an example of a photo/video window). Finally, order command button 250 is used if the patron wishes to order the item, in this case the “Peppercorn Mushroom Sirloin” steak.

FIG. 3 is a screen depiction of an item's detailed description being provided using the electronic menu. When the patron requests a detailed description (such as by selecting details command button 140 shown in FIG. 1), details window 300 is displayed. Details window 300 provides detailed description 310 of a particular item. In the example shown in FIG. 3, the detailed description corresponds to the “Peppercorn Mushroom Sirloin,” steak as indicated by the title bar of window 300. From window 300, the patron can navigate to other windows. Back command button 320 takes the patron back to the window from which the patron came, similar to a back command button in an Internet browser application. Nutrition command button 330 is used to display a window with nutrition information for the selected item, in this case the “Peppercorn Mushroom Sirloin” steak (see FIG. 2 for an example of a nutrition window). Likewise, photo command button 340 is used to display a photograph and/or video of the “Peppercorn Mushroom Sirloin” steak (see FIG. 4 for an example of a photo/video window). Finally, order command button 350 is used if the patron wishes to order the item, in this case the “Peppercorn Mushroom Sirloin” steak.

FIG. 4 is a screen depiction of photographic and video information being provided for a menu item using the electronic menu. When the patron requests a photograph or video (such as by photo command button 150 shown in FIG. 1), photo/video window 400 is displayed. Photo/video window 300 provides photograph 410 of a particular item. In the example shown in FIG. 4, the detailed description corresponds to the “Peppercorn Mushroom Sirloin,” steak as indicated by the title bar of window 400. The patron can enlarge the photograph by selecting command button 420. The patron can also view a video of the selected item, such as the item being served, in window 430. The patron selects view video command button 440 to begin playing the video. From window 400, the patron can navigate to other windows. Back command button 450 takes the patron back to the window from which the patron came, similar to a back command button in an Internet browser application. Nutrition command button 460 is used to display a window with nutrition information for the selected item, in this case the “Peppercorn Mushroom Sirloin” steak (see FIG. 2 for an example of a nutrition window). Details command button 467 is used to display a window with a detailed description of the item, in this case the “Peppercorn Mushroom Sirloin” steak (see FIG. 3 for an example of a detailed description window). Finally, order command button 480 is used if the patron wishes to order the item, in this case the “Peppercorn Mushroom Sirloin” steak.

FIG. 5 is a screen depiction of an order detail being provided for a menu item using the electronic menu. This window is displayed when the patron indicates that he or she would like to order the selected item, in this case the “Peppercorn Mushroom Sirloin” stead, as indicated by the title bar of order window 500. Several windows (shown in FIGS. 1-4) have order command buttons that are used to navigate to window 500 shown in FIG. 5. Order window 500 includes various fields for indicating a patron's preferences as well ordering additional items, such as side dishes. Textbox 505 is provided for the patron to enter the name of the person for whom the order is being placed. This is helpful if orders for multiple patrons are being placed from a single electronic menu device so that the wait staff will know the correct patron's name when delivering the food. Options may be provided based upon the type of food that is being ordered. In the example shown, a steak is being ordered and the patron has a choice as to its preparation. Option buttons 510 are used for the patron to select how the steak should be prepared. In the example shown, the patron has selected that the steak be cooked “medium well.”

Based upon the item being ordered, no additional items or several additional items may be included. In the example shown, the patron is informed that the steak includes two side dishes with additional sides being available for a given price. If the patron selects more than the allowed number (two), then the amount of the additional sides will be included in the bill. In the example shown in FIG. 5, the patron can select between six different side dishes. One of the items (the Cesar Salad) is noted as being available for an additional charge. In the example shown, the patron has ordered two side dishes (the mashed potatoes (item 522) and the green beans(item 542)), as indicated by respective checked option boxes 520 and 540. Similar to the main menu screen shown in FIG. 1, FIG. 5 also provides a number of command buttons used to view various information concerning a particular item. These command buttons include a button to view details about an item, a photo (or video) of the item, nutrition information concerning the item, and a button to order the item. In the example shown, the Mashed Potatoes item 522 is associated with details command button 524, photo command button 526, nutrition command button 528, and order command button 530. In the example shown, the patron has ordered the mashed potatoes with sour cream and no butter (order summary 534), and has ordered the green beans with butter (order summary 544).

Save selections command button 580 is used when the patron is finished making selections and wishes to save the selections and return to the previously displayed screen (such as menu screen 100 shown in FIG. 1). Remove item command button 590 is used if the patron changes his or her mind and decides to remove the main item, in this case the “Peppercorn Mushroom Sirloin” steak, from the patron's order and return to the previously displayed screen.

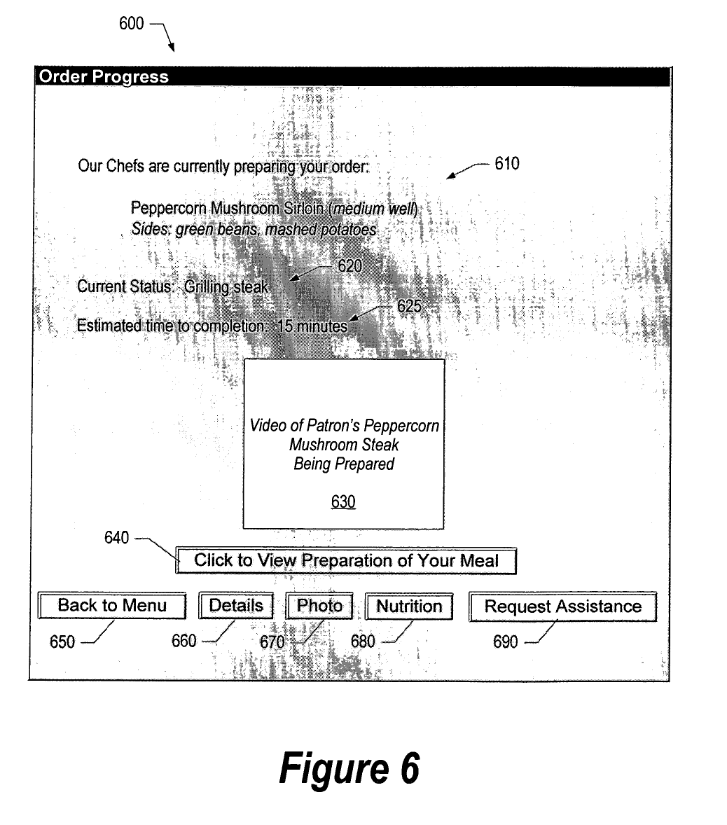

FIG. 6 is a screen depiction of order progress information being provided using the electronic menu. If the electronic menu device is left at the patron's table after the patron has ordered his or her meal, order progress window 600 is provided to the patron on the patron's electronic menu device. Order summary 610 is a summary description of the patron's order. Current status 620 shows the status of the food preparation process. In the example shown in FIG. 6, the current status is that the patron's steak is currently being grilled. Completion estimate 625 shows the amount of time expected to complete the patron's order.

In one embodiment, the patron can view the actual preparation of the patron's order. Video window 630 provides a video feed of the order being prepared. When requested by the patron pressing view command button 640, the video feed from the camera in the kitchen area that is directed towards the patron's order is wirelessly sent from the restaurant server to the patron's electronic menu device and displayed in window 630.

Menu command button 650 takes the patron back to the electronic menu so the patron can view other items or make additional orders, such as ordering dessert (see FIG. 1 for an example of an electronic menu). Details command button 660 is used to display a window with a detailed description of the item, in this case the “Peppercorn Mushroom Sirloin” steak (see FIG. 3 for an example of a detailed description window). Likewise, photo command button 670 is used to display a photograph and/or video of the “Peppercorn Mushroom Sirloin” steak (see FIG. 4 for an example of a photo/video window). Nutrition command button 680 is used to display a window with nutrition information for the selected item, in this case the “Peppercorn Mushroom Sirloin” steak (see FIG. 2 for an example of a nutrition window). Finally, request assistance command button 690 is used to request assistance from the wait staff. If assistance is requested, a wireless message is sent from the electronic menu device to the restaurant server and relayed to a wait staff member, informing the member that the patron needs assistance along with providing location information (table number, etc.) corresponding to the patron.

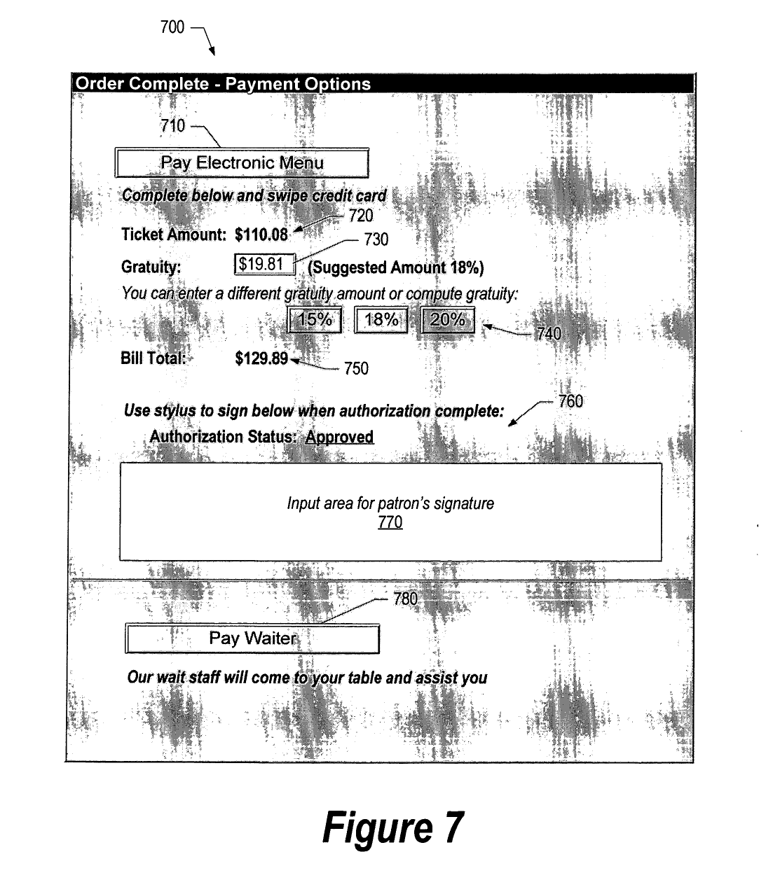

FIG. 7 is a screen depiction of a payment screen being provided using the electronic menu. Payment window 700 is provided to the patron when the patron is ready to check out. The payment window allows the patron to pay at the electronic menu device or to request a member of the wait staff for making payment. To pay at the electronic menu device, the patron fills out the gratuity amount, based upon invoice amount 720, by entering the gratuity into gratuity textbox 730. To facilitate accurate gratuity amounts, gratuity command buttons 740 are provided to, upon request, automatically compute a gratuity amount and insert the computed gratuity into textbox 730. The total invoice, including gratuity, is printed at 750.

The patron selects pay electronic menu command button 710 to process a credit card payment. In one embodiment, a credit card reader is attached to the electronic menu device so that the patron simply swipes the credit card using the reader. In an alternative embodiment, a textbox can be used for entering credit card information such as the patron's name, credit card number, expiration date, and any other information required by the credit card company.

Authorization summary 760 provides status on the patron's credit card authorization. In one embodiment, such as with a electronic menu device that includes tablet PC functionality, the patron uses at stylus to provide a signature in input area 770. In another embodiment, a paper statement is provided, either by wait staff or printed from the electronic menu device, that is signed by the patron using a standard pen. If the patron chooses to provide payment, such as cash, to a member of the wait staff, the patron selects pay waiter command button 780 and a member of the wait staff is notified and provides assistance to the patron.

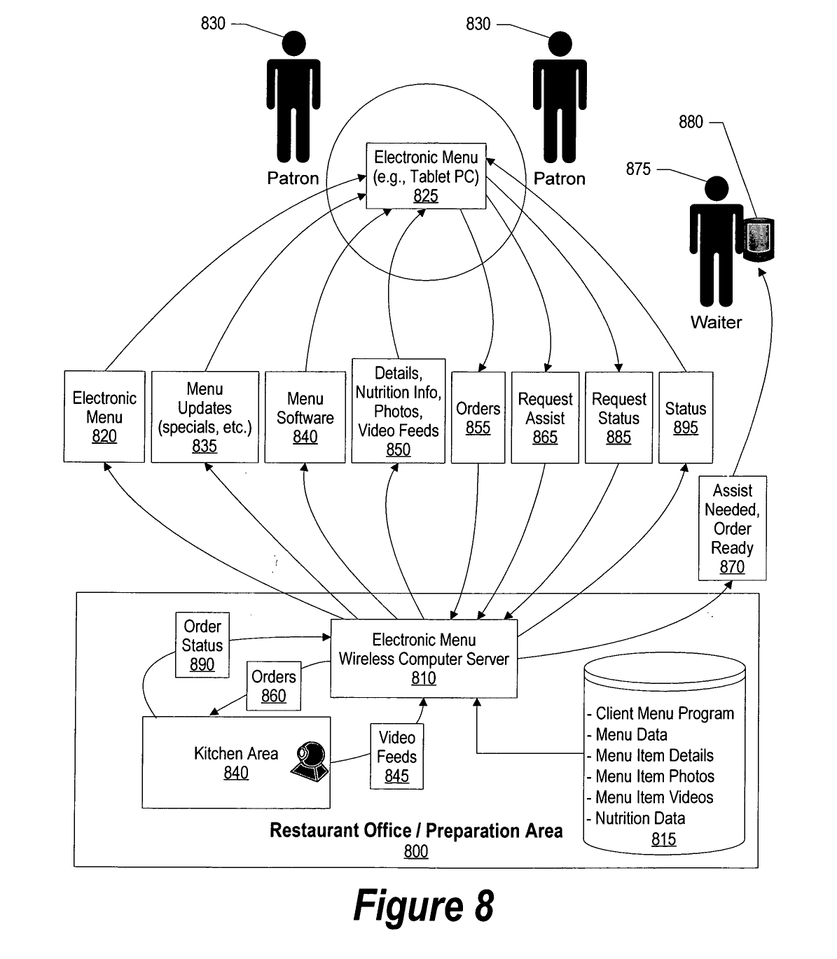

FIG. 8 is a data flow diagram showing data flowing between the electronic menu device and the restaurant server. The restaurant office and preparation areas 800 house restaurant server 810 which is a computer system with the ability to wirelessly communicate with the various electronic menu devices located throughout the restaurant. In one embodiment, the wireless communications are facilitated by wireless modems located in the electronic menu devices and in restaurant server 810. When a patron is seated, such as patrons 830, the patron is assigned electronic menu device 825.

Preferably prior to the assignment, the electronic menu device is loaded with electronic menu 820, any menu updates, such as specials, 835, and menu software 840 used to control the patron's use of the electronic menu device and provide the various functionality. Restaurant server 810 retrieves this information from nonvolatile storage area 815, such as a fixed disk drive. Detailed descriptions, nutritional information, photographic material (850) can be provided before assignment of the electronic menu device or, if electronic menu device storage space is limited, some or all of this information can reside on server 810 and be wirelessly transmitted to the electronic menu device when requested by the patron. Video feeds 850, such a video feed of the patron's order being prepared, are also provided to the electronic menu device from the restaurant server.

When patrons 830 have used electronic menu device 825 and made their selections, orders 855 are wirelessly transmitted from electronic menu device 825 to electronic menu device 810. Order details 860 are provided to kitchen area for actual preparation of the order. If, at any time, the patrons require assistance, they use electronic menu device to indicate their request and assistance request 865 is wirelessly transmitted from electronic menu device 825 to restaurant server 810. The appropriate member of the wait staff is retrieved based upon the patron's location or assignment and assistance request 870 is wirelessly transmitted to portable device 880, such as a digital assistant device, which is carried by member of the wait staff 875. If a video feed is requested, a video camera in kitchen area 840 captures video of the patron's order being prepared and video feed 845 which is connected to restaurant server 810 and wirelessly transmitted to electronic menu device 825 for viewing by the patrons.

Patrons 830 can also use electronic menu device 825 to request status, whereupon status request 885 is wirelessly transmitted from electronic menu device 825 to restaurant server 810. Status information 890, such as the current preparation activity and the estimated time to completion, is provided by the kitchen area to restaurant server 810. The restaurant server forwards status information 895 to electronic menu device using a wireless transmission.

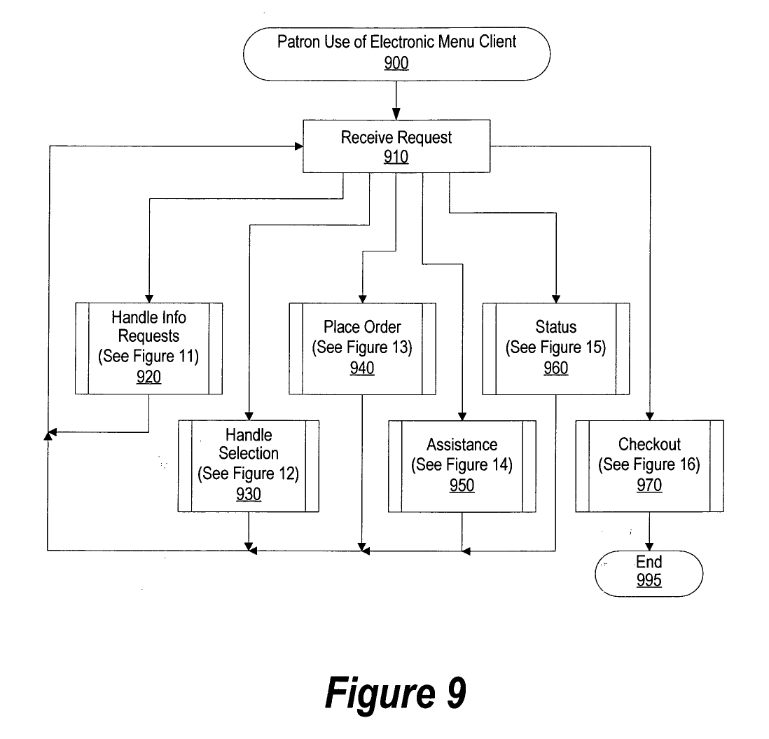

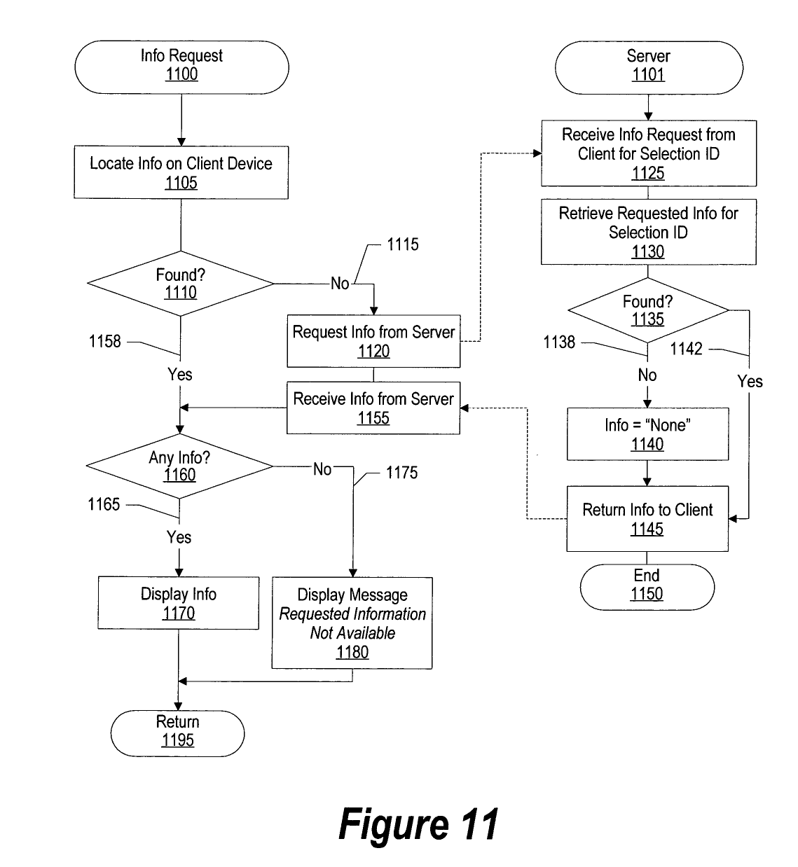

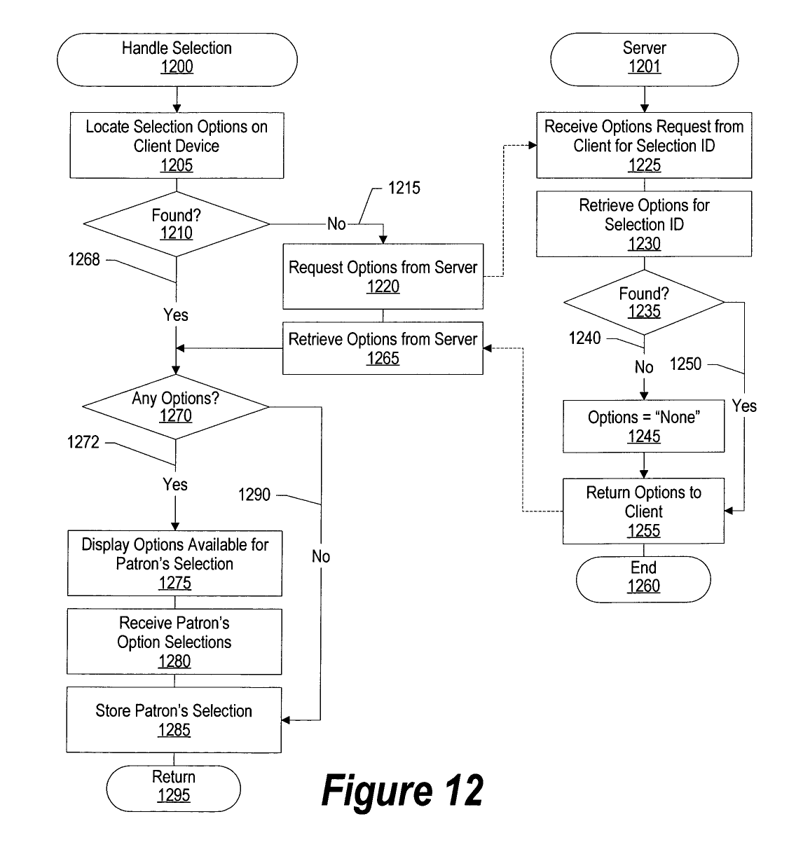

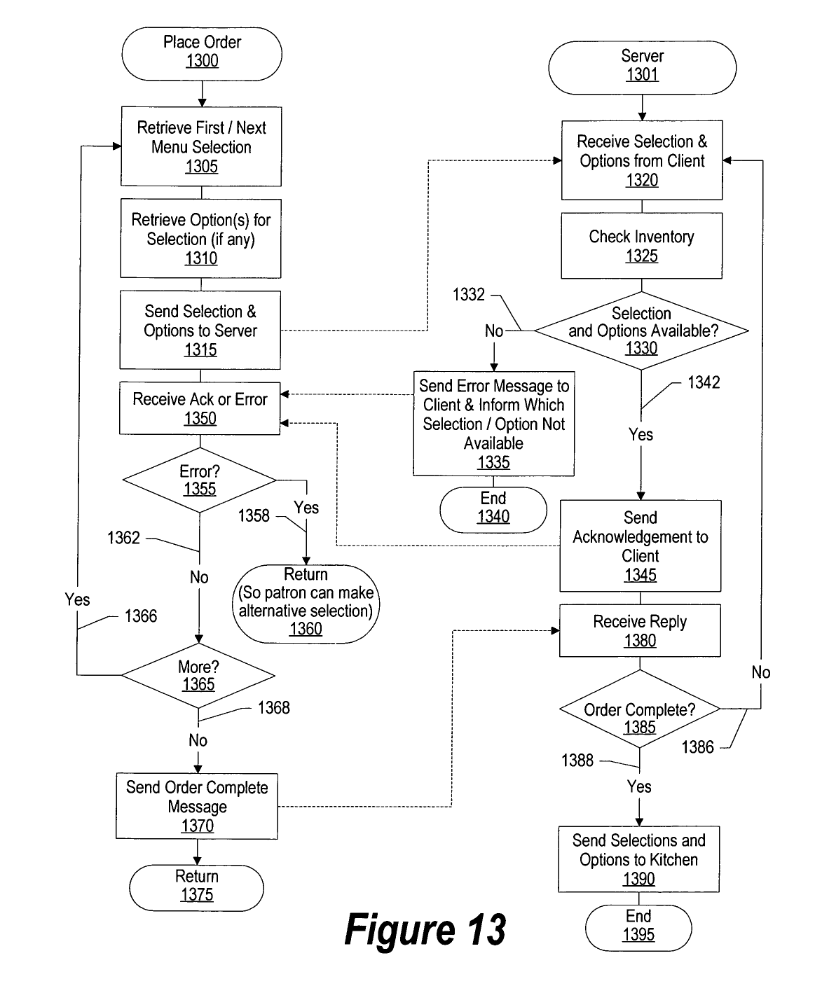

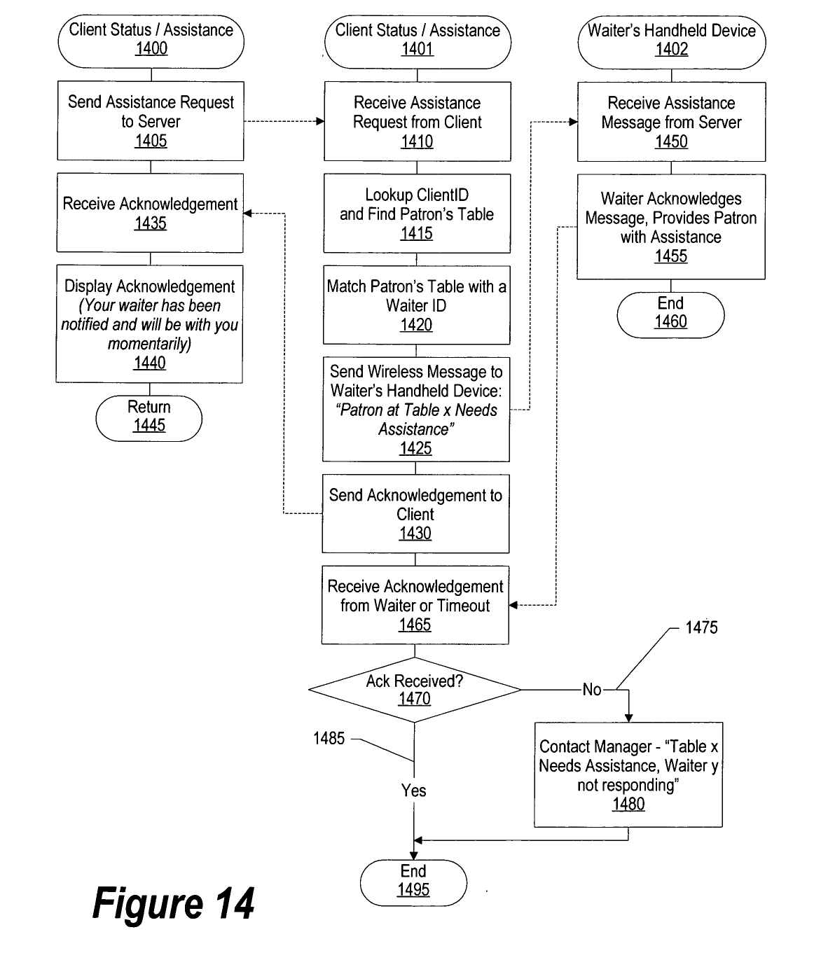

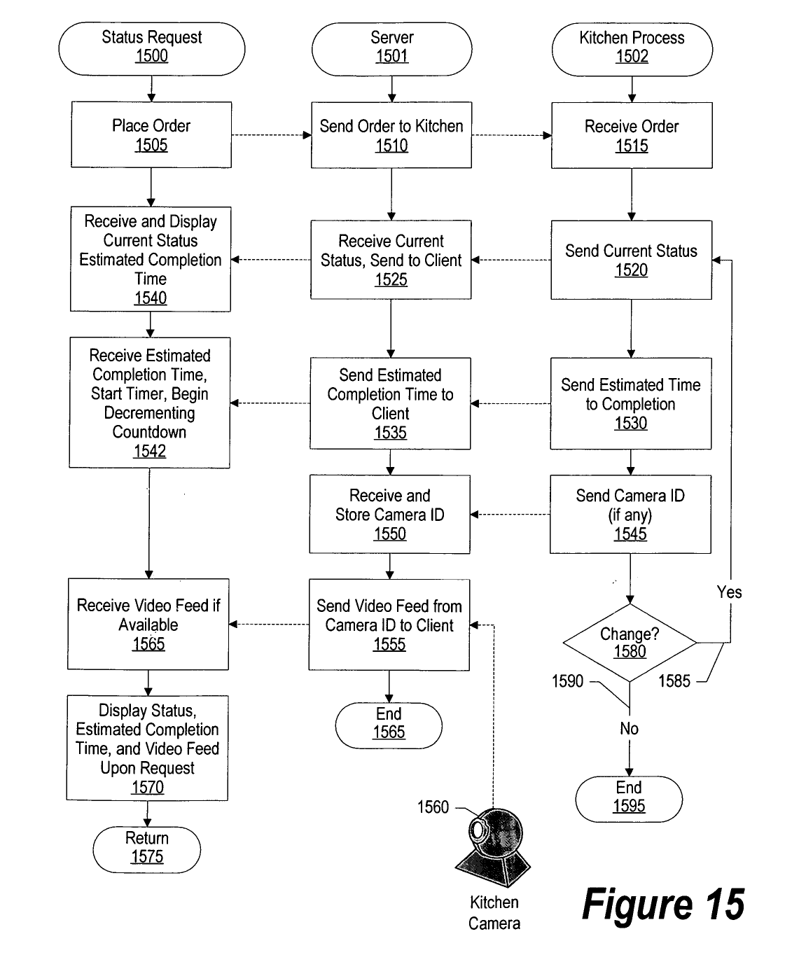

FIG. 9 is a high level flowchart showing functions performed by the patron using the electronic menu device. At step 910, the electronic menu device receives the patron's request. If the request was for information, handle information requests is performed (predefined process 920, see FIG. 11 and corresponding text for processing details). If the request was to handle a selection of an item from the menu, predefined process 930 is performed (see FIG. 12 and corresponding text for processing details). If the request was to place an order, predefined process 940 is performed (see FIG. 13 and corresponding text for processing details). If the request was for assistance, predefined process 950 is performed (see FIG. 14 and corresponding text for processing details). And, if the request was for status, predefined process 960 is performed (see FIG. 15 and corresponding text for processing details).

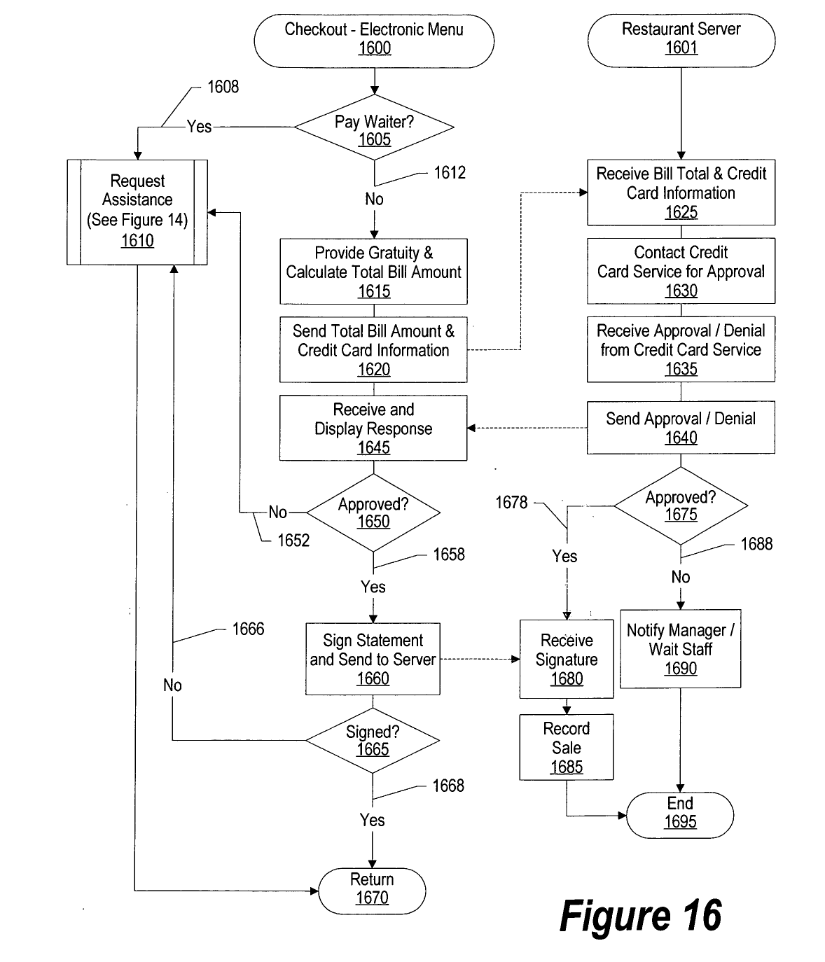

After each of the aforementioned processes are performed, processing loops back to receive the patron's next request at step 910. This looping continues until the patron requests to checkout, at which point predefined process 970 is performed (see FIG. 16 and corresponding text for processing details), and processing ends at 995. When processing ends, the electronic menu device can be assigned to another patron with the aforementioned processes being performed for the newly assigned patron until the patron checks out.

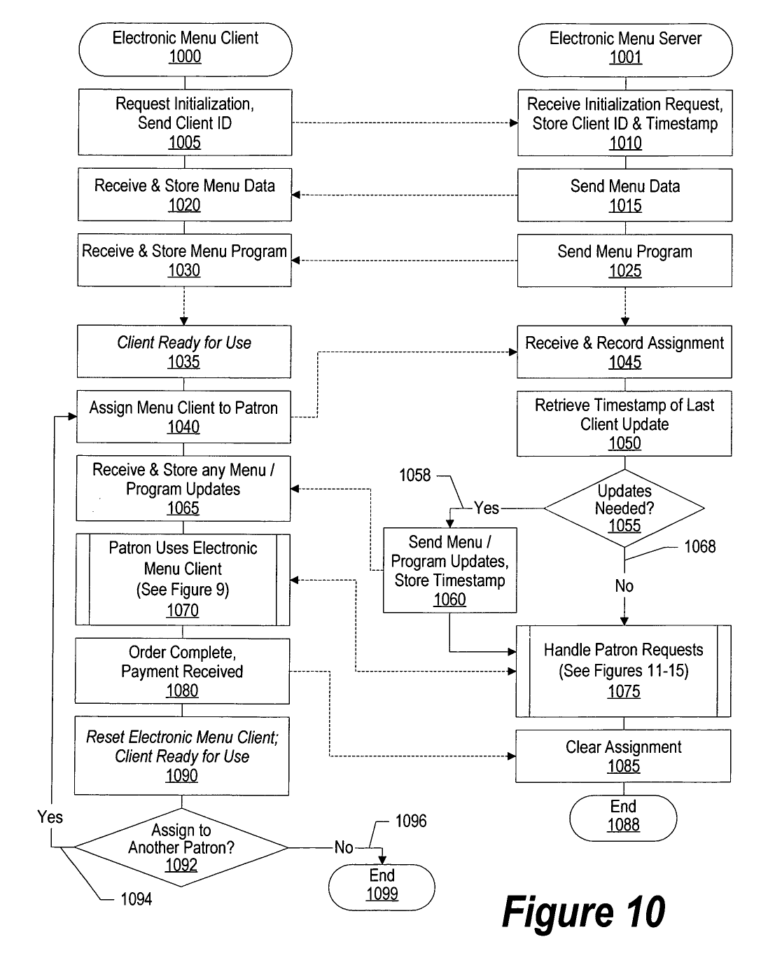

FIG. 10 is a flowchart showing the steps taken in initializing an electronic menu device from the restaurant server. Electronic menu device processing commences at 1000 and restaurant server processing commences at 1001. At step 1005, the electronic menu device sends a request to the restaurant server requesting initialization and providing the restaurant server with the electronic menu device's unique identifier. At step 1010 the restaurant server receives the request and responds by sending menu data (step 1015) and menu software program (step 1025) to the electronic menu device. The menu data an software program are received by the electronic menu device at steps 1020 and 1030, respectively. At this point, the electronic menu software in the electronic menu device is initialized and the electronic menu device is ready for use by a patron (step 1035).

When a patron enters the restaurant, the electronic menu device is provided to the patron and the wait staff, such as the host or hostess, assigns the electronic menu device to the patron (step 1040). This information is transmitted to the restaurant server whereupon, at step 1045, the restaurant server receives and records the assignment of the electronic menu device to the patron. The assignment also includes the table or other location information so that the wait staff can easily locate the patron should the patron require assistance or upon completion of the patron's order. The restaurant server retrieves a timestamp indicating the last time that the electronic menu device that was assigned to the patron was updated. Based upon this information, a determination is made as to whether updates are needed by the electronic menu device (decision 1055). If updates are needed, such as new program files or new menu data (e.g., daily specials), then decision 1055 branches to “yes” branch 1058 whereupon the needed program updates and menu data are sent to the electronic menu device and the current timestamp is written recording the electronic menu device's last update time (step 1060). The electronic menu device receives any program or menu updates at step 1065.

The patron then uses the electronic menu device to make selections and order (predefined process 1070, see FIG. 9 and corresponding text for processing details). The restaurant server processes the patron's requests accordingly (predefined process 1075, see FIGS. 11-15 and corresponding text for processing details). When the patron is finished, the patron pays at either the electronic menu device or pays a wait staff member (step 1080). The restaurant server responds by clearing the assignment at step 1085 and restaurant server processing ends at 1088.

The electronic menu device is reset and made ready for another patron to use (step 1090). A determination is made as to whether the electronic menu device is assigned to another patron (decision 1092). If it is assigned to another patron, decision 1092 branches to “yes” branch 1094 which loops back to assign the electronic menu device to another patron and process the next patron's requests. This looping continues until the electronic menu device is not assigned to another patron (e.g., the restaurant is closing and the electronic menu device is shutdown), at which point decision 1092 branches to “no” branch 1096 and electronic menu device processing ends at 1099.

FIG. 11 is a flowchart showing the steps taken to handle an information request received from a patron of the electronic menu device. Information request processing at the electronic menu device commences at 1100 whereupon, at step 1105, the memory and nonvolatile storage within the electronic menu device are searched to try and locate the requested information, such as a detailed description of a menu item. A determination is made as to whether the requested information was found on the electronic menu device (decision 1110). If the information was not found on the electronic menu device, decision 1110 branches to “no” branch 1115 whereupon, at step 1120, the information is requested from the restaurant server by sending the restaurant server a wireless message.

Restaurant server processing commences at 1101 whereupon, at step 1125, the restaurant server receives a request for information from an electronic menu device. The request includes the unique identifier of the electronic menu device making the request. At step 1130, the restaurant server searches its memory areas and nonvolatile storage areas for the requested information. A determination is made as to whether the requested information was found (decision 1135). If the requested information was not found by the restaurant server, decision 1135 branches to “no” branch 1138 whereupon, at step 1140, the information is set to “none.” On the other hand, if the requested information was found, decision 1135 branches to “yes” branch 1142 bypassing step 1140. At step 1145 the information (either “none” or the retrieved information) is returned to the requesting electronic menu device and restaurant server processing ends at 1150.

Returning to electronic menu device processing, the electronic menu device receives the requested information from the server at step 1155. Returning to decision 1110, if the information was found on the electronic menu device, decision 1110 branches to “yes” branch 1158 bypassing steps 1120 and 1155. A determination is made as to whether any information has been gathered to display to the patron (decision 1160). If information was gathered, decision 1160 branches to “yes” branch 1165 whereupon, at step 1170, the retrieved information is displayed to the patron on the electronic menu device's display screen. On the other hand, if no information was gathered, decision 1160 branches to “no” branch 1175 whereupon, at step 1180, a message is displayed to the patron using the electronic menu device's display screen indicating that the requested information is not available. After the requested information or the message is displayed to the patron, processing returns at 1195.

FIG. 12 is a flowchart showing the steps taken to process a patron's selection from the electronic menu (for screen depictions of a selection being made, see the example shown in FIGS. 1 and 5 where the patron orders a “Peppercorn Mushroom Sirloin” steak and two side orders. Processing commences at 1200 whereupon, at step 1205, the memory and nonvolatile storage within the electronic menu device are searched to try and locate the selection options that pertain to the selected item, such as cooking instructions and side orders. A determination is made as to whether selection options were found on the electronic menu device (decision 1210). If the selection options were not found on the electronic menu device, decision 1210 branches to “no” branch 1215 whereupon, at step 1220, the selection options are requested from the restaurant server by sending the restaurant server a wireless message.

Restaurant server processing commences at 1201 whereupon, at step 1225, the restaurant server receives a request for selection options from an electronic menu device. The request includes the unique identifier of the electronic menu device making the request and the selection identifier that uniquely identifies the selection. At step 1230, the restaurant server searches its memory areas and nonvolatile storage areas for the selection options. A determination is made as to whether the selection options were found (decision 1235). If the selection options were not found by the restaurant server, decision 1235 branches to “no” branch 1240 whereupon, at step 1245, the options are set to “none.” On the other hand, if the selection options were found, decision 1235 branches to “yes” branch 1250 bypassing step 1245. At step 1255 the selection options (either “none” or the retrieved selection options) are returned to the requesting electronic menu device and restaurant server processing ends at 1160.

Returning to electronic menu device processing, the electronic menu device receives the requested selection options from the server at step 1265. Returning to decision 1210, if the selection options were found on the electronic menu device, decision 1210 branches to “yes” branch 1268 bypassing steps 1220 and 1265. A determination is made as to whether any selection options have been gathered to display to the patron (decision 1270). If selection options were gathered, decision 1270 branches to “yes” branch 1272 whereupon, at step 1275, the options that are available for the patron's selection are displayed on the electronic menu device's display screen. At step 1280, the electronic menu device receives the patron's option selections, and at step 1285, the patron's option selections are stored, and processing returns at 1295.

On the other hand, if there are no options corresponding to the patron's selection, decision 1270 branches to “no” branch 1290 bypassing steps 1275-1285 and processing returns at 1295.

FIG. 13 is a flowchart showing the steps taken by the electronic menu device and the restaurant server to place an order after the patron has made his or her selections and selected any available options for the selections. Electronic menu device processing commences at 1300 whereupon, at step 1305, the electronic menu device retrieves the first menu selection from memory or nonvolatile storage. At step 1310, any options, such as side orders and cooking instructions, are retrieved for the menu selection. At step 1315, the electronic menu device sends the patron's selection and options for the selection to the restaurant server using a wireless transmission.

Restaurant server processing commences at 1301 whereupon, at step 1320, the restaurant server receives a selection and any options from the patron's electronic menu device. At step 1325, the restaurant server checks available inventory to ensure that the selection and/or options are available. A determination is made as to whether the selection and options are available (decision 1330). If the selections and/or one or more of the options are not available, decision 1330 branches to “no” branch 1332 whereupon, at step 1335, an error message is sent to the patron's electronic menu device and informing the patron of which selection/option(s) are unavailable, and restaurant server processing ends at 1340. On the other hand, if the selection and options are available, decision 1330 branches to “yes” branch 1342 whereupon, at step 1345 an acknowledgement is sent to the patron's electronic menu device in a wireless message.

Returning to electronic menu device processing, an acknowledgement or an error is received at step 1350. A determination is made as to whether an error was received (decision 1355). If an error was received, decision 1355 branches to “yes” branch 1358 whereupon electronic menu device processing returns so that the patron can make an alternative selection. On the other hand, if an error was not received, decision 1355 branches to “no” branch 1362 whereupon a determination is made as to whether there are more menu selections that have been made by the patron that need to be transmitted to the restaurant server (decision 1365). If there are more menu selections to process, decision 1365 branches to “yes” branch 1366 which loops back to retrieve and process the patron's next menu selection. This looping continues until there are no more menu selections to process, at which point decision 1365 branches to “no” branch 1368 whereupon, at step 1370, a message is sent to the restaurant server notifying the restaurant server that there are no more selections in the patron's order, and electronic menu device processing returns at 1375.

Returning to restaurant server processing, the restaurant server receives a reply at 1380. A determination is made as to whether the reply indicates that the order has been completely sent to the server (decision 1385). If the order has not been completely sent, decision 1385 branches to “no” branch 1386 which loops back to receive and process the next selection from the electronic menu device. This looping continues until the restaurant server receives a reply indicating that the patron's order has been completely sent and received, at which point decision 1385 branches to “yes” branch 1388 whereupon, at step 1390, all of the menu selections and options ordered by the patron are sent to the kitchen for preparation. Restaurant server processing thereafter ends at 1395.

FIG. 14 is a flowchart showing the steps taken to respond to an assistance request received from a patron that is using an electronic menu device. Electronic menu device processing commences at 1400 whereupon, at step 1405, the patron using the electronic menu device requests assistance and this request is sent to the restaurant server.

Restaurant server processing commences at 1401 whereupon, at step 1410 the assistance request is received from a patron's electronic menu device. The restaurant server uses the identifier of the electronic menu device to lookup the patron's table to which the electronic menu device has been assigned (step 1415). The table identifier, such as a table number, is matched against an identifier for a member of the wait staff at step 1420. At step 1425, a wireless message is sent to a handheld device assigned to the wait staff member that informs the member that a particular patron at the identified table has requested assistance and, at step 1430, an acknowledgement is sent to the patron's electronic menu device. Returning to the patron's electronic menu device processing, the acknowledgement is received at step 1435 and a message is displayed at step 1440 indicating that a member of the wait staff will provide assistance momentarily. Electronic menu device processing thereafter returns at 1445.

Wait staff processing commences at 1402 whereupon, at step 1450, the handheld unit assigned to the wait staff member receives a message from the restaurant server that a particular patron has requested assistance. At step 1455, the wait staff member acknowledges the request and walks to the patron's table to provide assistance. Wait staff handheld processing thereafter ends at 1460.

Returning to restaurant server processing, at ste[ 1465, the restaurant server receives an acknowledgement from the wait staff member who is using the handheld device. A determination is made as to whether an acknowledgement is received from the wait staff member within a given period of time (decision 1470). If an acknowledgement was not received, decision 1470 branches to “no” branch 1475 whereupon, at step 1480, the restaurant server contacts another wait staff member or a manager to provide the patron with assistance. On the other hand, if an acknowledgement is received within the time period, decision 1470 branches to “yes” branch 1485 bypassing step 1480. Restaurant server processing thereafter ends at 1495.

FIG. 15 is a flowchart showing the steps taken to respond to a status inquiry request received from a patron that is using an electronic menu device. Electronic menu device processing commences at 1500 whereupon, at step 1505 the patron places an order. Restaurant server processing commences at 1501 whereupon, at 1510 the order is received from the patron and sent to the kitchen for preparation. Kitchen processing commences at 1502 whereupon, at step 1515 the patron's order is received and the kitchen staff commences preparation of the patron's order.

At 1520, the kitchen sends an initial status of the order's preparation to the restaurant server. The restaurant server, at step 1525, receives the current status from the kitchen process and forwards the status information to the patron's electronic menu device. The patron's electronic menu device receives and displays the current status of the order at step 1540.

Returning to the kitchen process, the kitchen process transmits an estimated time to completion for the order at step 1530. The estimated time is received by the restaurant server and forwarded to the patron's electronic menu device at step 1535. At step 1542, the estimated time to complete the order is received at patron's electronic menu device and a decrementing counter is started beginning at the estimated time.

Returning to the kitchen process once again, a camera identifier corresponding to a camera that is currently capturing video of the area of the kitchen where the patron's order is being prepared is sent to the restaurant server at step 1545. The restaurant server receives and stores the camera identifier at step 1550. At step 1555, the restaurant server begins sending a video feed from camera 1560, where camera 1560 corresponds to the received camera identifier, to the patron's electronic menu device. Restaurant server processing thereafter ends at 1565.

The video feed is received by the patron's electronic menu device at step 1565. At step 1570 the information received from the restaurant server is displayed on the patron's electronic menu device. This information includes the current status of the order, the decrementing counter representing the estimated time to completion, and the video feed (if available), showing the patron's order being prepared by the kitchen staff. Patron electronic menu device processing thereafter returns at 1575.

Returning to the kitchen process, a determination is made as to whether there are any changes to the order's status, estimated time to completion, or the camera identifier corresponding to the camera being used to video the patron's order being prepared (decision 1580). An example of a change would be when an order moves from one preparation area to another, it would be likely that both the current status and camera identifiers would change. If the kitchen process notices any change in the status, completion time, or camera identifier, decision 1580 branches to “yes” branch 1585 which loops back to capture the changed information and transmit any changes to the restaurant server which, in turn, passes the changed information back to the patron's electronic menu device. This looping continues until there are no more changes (i.e., the order is complete), at which time decision 1580 branches to “no” branch 1590 and processing ends at 1595.

FIG. 16 is a flowchart showing the steps taken to handle payment and checkout by the patron using the electronic menu device. Processing at the patron's electronic menu device commences at 1600 whereupon a determination is made as to whether the patron wishes to use the electronic menu device for checking out or would rather pay a member of the wait staff (decision 1605). If the patron would rather pay a member of the wait staff, decision 1605 branches to “yes” branch 1608 whereupon the patron's electronic menu device sends a message to the restaurant server that the patron is requesting assistance and a member of the wait staff is notified to help the patron (predefined process 1610, see FIG. 14 and corresponding text for processing details).

On the other hand, if the patron chooses to pay using the electronic menu device, decision 1605 branches to “no” branch 1612 whereupon, at step 1615 the patron decides how much gratuity to pay the waiter and the total bill amount (including gratuity) is computed. At step 1620, the total bill amount and the patron's credit card information are sent to the restaurant server for processing.

Restaurant server processing commences at 1601 whereupon, at step 1625 the restaurant server receives the patron's bill total and the patron's credit card information. At step 1630 the restaurant server contacts a credit card service for approval of the charge to the patron's credit card. At step 1635, the restaurant server receives an approval or a denial from the credit card service and, at step 1640, the approval or denial is sent to the patron's electronic menu device.

Returning to patron's electronic menu device processing, the approval or denial is received and displayed at the electronic menu device at step 1645. A determination is made as to whether the charge was approved (decision 1650). If the charge was not approved, decision 1650 branches to “no” branch 1652 whereupon the patron's electronic menu device requests assistance from a member of the restaurant's wait staff (predefined process 1610, see FIG. 14 and corresponding text for processing details). In another embodiment, the patron could be given the opportunity to provide a information for different credit card and the second credit card could be processed before a member of the wait staff is notified. On the other hand, if the charge to the credit card was approved, decision 1650 branches to “yes” branch 1658 whereupon, at step 1660 the patron signs a credit card statement and the signature is sent to the restaurant server (see FIG. 7, element 770 for an example of an electronic menu with an input area for the patron to use when signing). A determination is made as to whether the patron signed the credit card statement within a given period of time (decision 1665). If the patron did not sign the statement, decision 1665 branches to “no” branch 1666 whereupon the patron's electronic menu device requests assistance from a member of the restaurant's wait staff (predefined process 1610, see FIG. 14 and corresponding text for processing details). On the other hand, if the patron signed the statement, decision 1665 branches to “yes” branch 1668 and electronic menu device processing returns at 1670. At this point the patron is finished using the electronic menu device and the electronic menu device can be assigned to a different patron.

Returning to restaurant server processing, a determination is made as to whether the patron's credit card charge was approved by the credit card service (decision 1675). If the charge was approved, decision 1675 branches to “yes” branch 1678 whereupon, at step 1680, the restaurant server receives a signature from the patron using the electronic menu device and, at step 1685, a record of the sale is made and recorded to a nonvolatile storage device. On the other hand, if the charge was denied, decision 1675 branches to “no” branch 1688 whereupon, at step 1690, a manager or member of the wait staff is notified of the situation. Restaurant server processing thereafter ends at 1695.

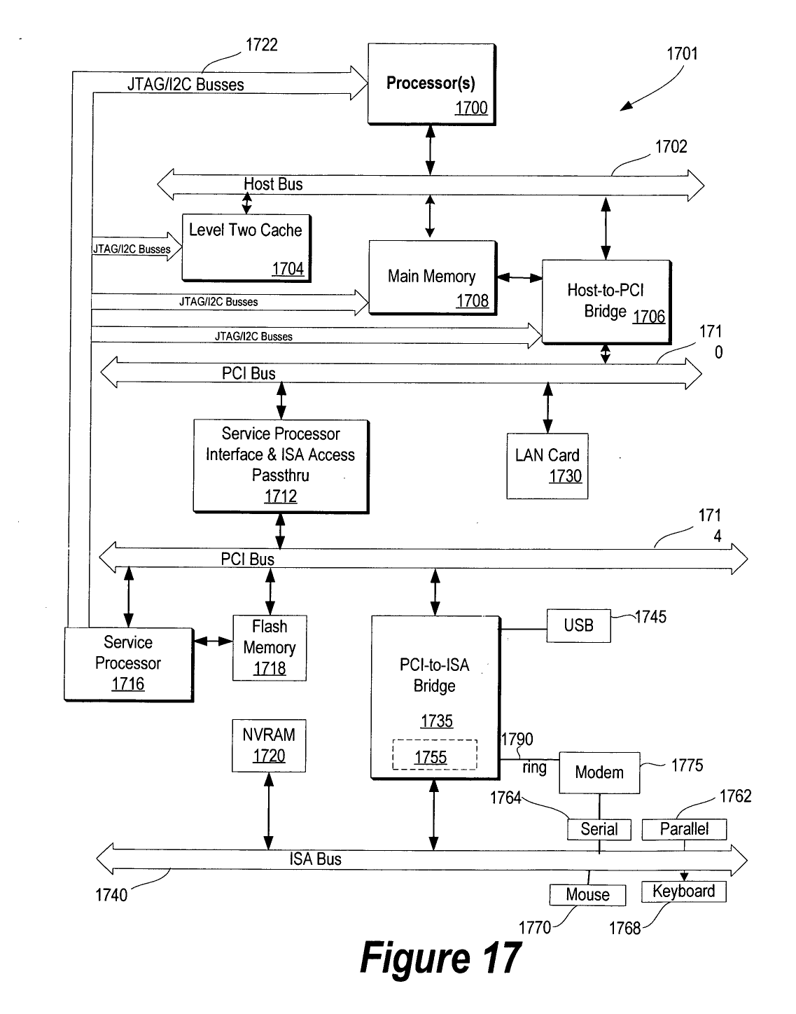

FIG. 17 illustrates information handling system 1701 which is a simplified example of a computer system capable of performing the computing operations described herein. Computer system 1701 includes processor 1700 which is coupled to host bus 1702. A level two (L2) cache memory 1704 is also coupled to host bus 1702. Host-to-PCI bridge 1706 is coupled to main memory 1708, includes cache memory and main memory control functions, and provides bus control to handle transfers among PCI bus 1710, processor 1700, L2 cache 1704, main memory 1708, and host bus 1702. Main memory 1708 is coupled to Host-to-PCI bridge 1706 as well as host bus 1702. Devices used solely by host processor(s) 1700, such as LAN card 1730, are coupled to PCI bus 1710. Service Processor Interface and ISA Access Pass-through 1712 provides an interface between PCI bus 1710 and PCI bus 1714. In this manner, PCI bus 1714 is insulated from PCI bus 1710. Devices, such as flash memory 1718, are coupled to PCI bus 1714. In one implementation, flash memory 1718 includes BIOS code that incorporates the necessary processor executable code for a variety of low-level system functions and system boot functions.

PCI bus 1714 provides an interface for a variety of devices that are shared by host processor(s) 1700 and Service Processor 1716 including, for example, flash memory 1718. PCI-to-ISA bridge 1735 provides bus control to handle transfers between PCI bus 1714 and ISA bus 1740, universal serial bus (USB) functionality 1745, power management functionality 1755, and can include other functional elements not shown, such as a real-time clock (RTC), DMA control, interrupt support, and system management bus support. Nonvolatile RAM 1720 is attached to ISA Bus 1740. Service Processor 1716 includes JTAG and I2C busses 1722 for communication with processor(s) 1700 during initialization steps. JTAG/I2C busses 1722 are also coupled to L2 cache 1704, Host-to-PCI bridge 1706, and main memory 1708 providing a communications path between the processor, the Service Processor, the L2 cache, the Host-to-PCI bridge, and the main memory. Service Processor 1716 also has access to system power resources for powering down information handling device 1701.

Peripheral devices and input/output (I/O) devices can be attached to various interfaces (e.g., parallel interface 1762, serial interface 1764, keyboard interface 1768, and mouse interface 1770 coupled to ISA bus 1740. Alternatively, many I/O devices can be accommodated by a super I/O controller (not shown) attached to ISA bus 1740.

In order to attach computer system 1701 to another computer system to copy files over a network, LAN card 1730 is coupled to PCI bus 1710. Similarly, to connect computer system 1701 to an ISP to connect to the Internet using a telephone line connection, modem 1775 is connected to serial port 1764 and PCI-to-ISA Bridge 1735.

While the computer system described in FIG. 17 is capable of executing the processes described herein, this computer system is simply one example of a computer system. Those skilled in the art will appreciate that many other computer system designs are capable of performing the processes described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method comprising:
wirelessly connecting a plurality of electronic menu devices with a restaurant server;
initializing at least one of the electronic menu devices, the initializing including:
sending menu data from the restaurant server to the electronic menu device;
receiving the menu data at the electronic menu device; and
storing the received menu data in storage located in the electronic menu device;
assigning the initialized electronic menu device to a patron;
receiving, at the electronic menu device, one or more requests from the patron;
transmitting a wireless request to the restaurant server in response to at least one of the requests;
receiving, at the restaurant server, the wireless request;
retrieving, at the restaurant server, requested information corresponding to the wireless request;
sending a wireless response to the electronic menu device, wherein the wireless response includes the requested information;
receiving the wireless response at the electronic menu device; and
displaying the requested information on a display screen connected to the electronic menu device.

2. The method of claim 1 further comprising:
periodically determining, at the restaurant server, whether menu updates are needed at the electronic menu device;
in response to determining that menu updates are needed, retrieving the menu updates, at the restaurant server, and sending the retrieved menu updates to the electronic menu device;
receiving the menu updates at the electronic menu device; and
storing the received menu updates in the electronic menu device's storage area.

3. The method of claim 1 further comprising:
receiving, at the electronic menu device, an information request from the patron;
in response to the requested information being stored in the electronic menu device's storage area:
retrieving the requested information; and
displaying the requested information on the electronic menu device's display screen;
in response to the requested information not being stored in the electronic menu device's storage area:
wirelessly sending an information request from the electronic menu device to the restaurant server;
receiving, at the restaurant server, the information request;
retrieving, at the restaurant server, the requested information;
wirelessly sending an information response to the electronic menu device, wherein the information response includes the retrieved requested information;
receiving, at the electronic menu device, the information response;
extracting the requested information from the information response; and
displaying the requested information on the electronic menu device's display screen.

4. The method of claim 1, wherein one of the requests is a selection of a menu item, the method further comprising:
determining whether any menu options correspond to the menu item selection; and
in response to determining that one or more options correspond to the menu item selection:
displaying the one or more options on the display screen;
receiving one or more option selections from the patron, wherein the option selections correspond to the options; and
storing the patron's menu item selection and the patron's one or more option selections.

5. The method of claim 1, wherein one of the requests is a request for assistance, the method further comprising:
looking up a location corresponding to the electronic menu device;
matching the location with a restaurant staff member; and
wirelessly sending an assistance message to a handheld computing device assigned to the restaurant staff member, wherein the assistance message includes the electronic menu device's location.

6. The method of claim 1, wherein one of the requests is a request for status, the method further comprising:
sending, from the restaurant server, an menu order corresponding to the patron to kitchen staff;
receiving, at the restaurant server, status information corresponding to the order, wherein the status information is selected from the group consisting of a status message, an estimated time to completion, and a video feed;
wirelessly sending, from the restaurant server to the electronic menu device, the status information corresponding to the order;
receiving, at the electronic menu device, the status information; and
displaying the received status information on the display screen.

7. The method of claim 1 further comprising:
receiving, at the electronic menu device, a gratuity amount and credit card information from the patron;
calculating a total bill amount that includes the gratuity amount;
wirelessly sending, from the electronic menu device to the restaurant server, the total bill amount and the credit card information;
receiving, at the restaurant server, the total bill amount and the credit card information;
attempting a charge using the credit card information and the total bill amount;
receiving, at the restaurant server, a response from the attempted charge;
in response to the charge being approved:
recording a sale corresponding to the total bill amount at the restaurant server;
wirelessly sending an approval message to the patron's electronic menu device;
receiving, at the electronic menu device, the approval message and displaying the approval message on the display screen; and
in response to the charge not being approved:
wirelessly sending a notification message to a handheld computing device assigned to the restaurant staff member.

8. An information handling system comprising:
one or more processors;
a memory accessible by the processors;
a wireless network interface that connects the information handling system to a plurality of electronic menu devices;
a nonvolatile storage device accessible by the processors; and
an electronic menu tool for providing electronic menus, the electronic menu tool including software code residing in the information handling system and the electronic menu devices and effective to:
initialize at least one of the electronic menu devices, the initialization including software code effective to:
send menu data from the information handling system to the electronic menu device;
receive the menu data at the electronic menu device; and
store the received menu data in storage located in the electronic menu device;
assign the initialized electronic menu device to a patron;
receive, at the electronic menu device, one or more requests from the patron;
transmit a wireless request to the in response to at least one of the requests;
receive, at the information handling system, the wireless request;
retrieve, at the information handling system, requested information corresponding to the wireless request;
send a wireless response to the electronic menu device, wherein the wireless response includes the requested information;
receive the wireless response at the electronic menu device; and
display the requested information on a display screen connected to the electronic menu device.

9. The information handling system of claim 8 further comprising software code effective to:
receive, at the electronic menu device, an information request from the patron;
in response to the requested information being stored in the electronic menu device's storage area:
retrieve the requested information; and
display the requested information on the electronic menu device's display screen;
in response to the requested information not being stored in the electronic menu device's storage area:
wirelessly send an information request from the electronic menu device to the information handling system;
receive, at the information handling system, the information request;
retrieve, at the information handling system, the requested information;
wirelessly send an information response to the electronic menu device, wherein the information response includes the retrieved requested information;
receive, at the electronic menu device, the information response;
extract the requested information from the information response; and
display the requested information on the electronic menu device's display screen;

10. The information handling system of claim 8, wherein one of the requests is a selection of a menu item, the information handling system further comprising software code effective to:
determine whether any menu options correspond to the menu item selection; and
in response to determining that one or more options correspond to the menu item selection:
display the one or more options on the display screen;
receive one or more option selections from the patron, wherein the option selections correspond to the options; and
store the patron's menu item selection and the patron's one or more option selections.

11. The information handling system of claim 8, wherein one of the requests is a request for assistance, the information handling system further comprising software code effective to:
look up a location corresponding to the electronic menu device;
match the location with a restaurant staff member; and
wirelessly send an assistance message to a handheld computing device assigned to the restaurant staff member, wherein the assistance message includes the electronic menu device's location.

12. The information handling system of claim 8, wherein one of the requests is a request for status, the information handling system further comprising software code effective to:
send, from the information handling system, an menu order corresponding to the patron to kitchen staff;
receive, at the information handling system, status information corresponding to the order, wherein the status information is selected from the group consisting of a status message, an estimated time to completion, and a video feed;
wirelessly send, from the information handling system to the electronic menu device, the status information corresponding to the order;
receive, at the electronic menu device, the status information; and
display the received status information on the display screen.

13. The information handling system of claim 8 further comprising software code effective to:
receive, at the electronic menu device, a gratuity amount and credit card information from the patron;
calculate a total bill amount that includes the gratuity amount;
wirelessly send, from the electronic menu device to the information handling system, the total bill amount and the credit card information;
receive, at the information handling system, the total bill amount and the credit card information;
attempt a charge using the credit card information and the total bill amount;
receive, at the information handling system, a response from the attempted charge;
in response to the charge being approved:
record a sale corresponding to the total bill amount at the information handling system;
wirelessly send an approval message to the patron's electronic menu device;
receive, at the electronic menu device, the approval message and displaying the approval message on the display screen; and
in response to the charge not being approved:
wirelessly send a notification message to a handheld computing device assigned to the restaurant staff member.

14. A computer program product stored in a computer operable media for proving electronic menus, said computer program product comprising software code effective to:
wirelessly connect a plurality of electronic menu devices with a restaurant server;
initialize at least one of the electronic menu devices, the initialization including:
send menu data from the restaurant server to the electronic menu device;
receive the menu data at the electronic menu device; and
store the received menu data in storage located in the electronic menu device;
assign the initialized electronic menu device to a patron;
receive, at the electronic menu device, one or more requests from the patron;
transmit a wireless request to the restaurant server in response to at least one of the requests;
receive, at the restaurant server, the wireless request;
retrieve, at the restaurant server, requested information corresponding to the wireless request;
send a wireless response to the electronic menu device, wherein the wireless response includes the requested information;
receive the wireless response at the electronic menu device; and
display the requested information on a display screen connected to the electronic menu device.

15. The computer program product of claim 14 further comprising software code effective to:
periodically determine, at the restaurant server, whether menu updates are needed at the electronic menu device;
in response to determining that menu updates are needed, software code effective to retrieve the menu updates, at the restaurant server, and software code effective to send the retrieved menu updates to the electronic menu device;
receive the menu updates at the electronic menu device; and
store the received menu updates in the electronic menu device's storage area.

16. The computer program product of claim 14 further comprising software code effective to:
receive, at the electronic menu device, an information request from the patron;
in response to the requested information being stored in the electronic menu device's storage area:
retrieve the requested information; and
display the requested information on the electronic menu device's display screen;
in response to the requested information not being stored in the electronic menu device's storage area:
wirelessly send an information request from the electronic menu device to the restaurant server;
receive, at the restaurant server, the information request;
retrieve, at the restaurant server, the requested information;
wirelessly send an information response to the electronic menu device, wherein the information response includes the retrieved requested information;
receive, at the electronic menu device, the information response;
extract the requested information from the information response; and
display the requested information on the electronic menu device's display screen;

17. The computer program product of claim 14, wherein one of the requests is a selection of a menu item, the computer program product further comprising software code effective to:
determine whether any menu options correspond to the menu item selection; and
in response to determining that one or more options correspond to the menu item selection:
software code effective to display the one or more options on the display screen;
software code effective to receive one or more option selections from the patron, wherein the option selections correspond to the options; and
software code effective to storing the patron's menu item selection and the patron's one or more option selections.

18. The computer program product of claim 14, wherein one of the requests is a request for assistance, the computer program product further comprising software code effective to:
look up a location corresponding to the electronic menu device;
match the location with a restaurant staff member; and
wirelessly send an assistance message to a handheld computing device assigned to the restaurant staff member, wherein the assistance message includes the electronic menu device's location.

19. The computer program product of claim 14, wherein one of the requests is a request for status, the computer program product further comprising software code effective to:
send, from the restaurant server, an menu order corresponding to the patron to kitchen staff;
receive, at the restaurant server, status information corresponding to the order, wherein the status information is selected from the group consisting of a status message, an estimated time to completion, and a video feed;
wirelessly send, from the restaurant server to the electronic menu device, the status information corresponding to the order;
receive, at the electronic menu device, the status information; and
display the received status information on the display screen.

20. The computer program product of claim 14 further comprising:
receive, at the electronic menu device, a gratuity amount and credit card information from the patron;
calculate a total bill amount that includes the gratuity amount;
wirelessly send, from the electronic menu device to the restaurant server, the total bill amount and the credit card information;
receive, at the restaurant server, the total bill amount and the credit card information;
attempt a charge using the credit card information and the total bill amount;
receive, at the restaurant server, a response from the attempted charge;
in response to the charge being approved, software code effective to:
record a sale corresponding to the total bill amount at the restaurant server;
wirelessly send an approval message to the patron's electronic menu device;
receive, at the electronic menu device, the approval message and displaying the approval message on the display screen; and
in response to the charge not being approved, software code effective to:
wirelessly send a notification message to a handheld computing device assigned to the restaurant staff member.
